(19) United States
(12) Patent Application Publication
(10) Pub. No.: US 2017/0033646 A1
(43) Pub. Date: Feb. 2, 2017

(54) ELECTRONIC-SWITCHING ELECTRIC MOTOR AND CORRESPONDING AIR PULSATION DEVICE

(71) Applicant: Valeo Systemes Thermiques, Le Mesnil Saint Denis (FR)

(72) Inventors: Geoffroy Capoulun, Versailles (FR); Alain Farkh, Montfort L'amaury (FR)

(73) Assignee: Valeo Systemes Thermiques, Le Mesnil Saint Denis (FR)

(21) Appl. No.: 15/221,787

(22) Filed: Jul. 28, 2016

(30) Foreign Application Priority Data
Jul. 28, 2015 (FR) 1557179

(51) Int. Cl. H02K 11/22; H02K 21/22; H02K 1/14; H02K 5/22; H02K 5/10; H02K 5/02

(52) U.S. Cl. CPC H02K 11/022; H02K 5/10; H02K 5/02; H02K 1/14; H02K 5/225; H02K 21/22

(57) ABSTRACT

An air pulsation device according to the invention comprises an electric motor (2) comprising a rotor and a stator (14).

The stator comprises teeth arranged so that an interspace (30) for winding a coil is formed between two adjacent teeth.

The stator is in contact with a means for supporting the electric motor, which is metallic and electrically connected to an electrical earth.

At least one screen (50) is electrically connected to the support means, the said at least one screen comprising closing means (62, 68) which extend axially so as to fill at least one of the said interspaces between two teeth of the stator (14).

The present invention relates to the sector of electric motors and in particular to the sector of electronic-switching motors. More specifically, the invention relates to air pulsation devices in motor vehicles comprising such electric motors.

An air pulsation device equipped with an electric motor according to the invention is, for example, used in a ventilation, heating and/or air-conditioning system of a motor vehicle.

Electronic-switching electric motors or brushless dc motors comprise a rotor and stator assembly, each of these components having, mounted on them, electromagnetic elements, the interaction of which causes displacement of the rotor relative to the stator. The rotor and the stator are mounted independently of each other in the said motor and it must be ensured that the relative positioning of these two components is correct for optimum operation of the motor. Moreover, current switching in the stator coils generates electromagnetic waves which may disturb the operation of other electronic apparatus arranged in the vicinity.

The present invention falls within this sector and aims to provide an electric motor and an associated air pulsation device which are able to limit the propagation of electromagnetic waves outside of the air pulsation device.

“Air pulsation device” is understood as meaning a device allowing air to be drawn in and blown out.

An air pulsation device comprises an electronic-switching electric motor which comprises a rotor and a stator. The electric motor may in particular comprise a ventilation wheel rotationally driven by an output shaft of the motor, and the rotor, which is adapted to revolve around the stator, may in particular be rotationally locked with the output shaft.

The stator has a plurality of teeth arranged radially in star-like manner around a longitudinal axis so that an interspace for winding a magnetic coil around each of the teeth is formed between two adjacent teeth.

According to the invention, the stator is in contact with a means for supporting the electric motor, the said support means being metallic and electrically connected to an electrical earth. Moreover, at least one screen is electrically connected to the support means, the said at least one screen comprising closing means which extend along the longitudinal axis so as to fill at least one of the said interspaces between two teeth of the stator.

This arrangement allows the formation of a conducting enclosure connected to the electrical earth, and therefore kept at a fixed potential, so as to form an electromagnetic shield able to contain inside the air pulsation device the electric field created by the switching of current in the stator coils.

According to a first series of characteristic features, considered singly or in combination, the following may be envisaged:
the screen extends transversely between the rotor and the stator
the screen extends over the whole surface of the stator
the screen has a substantially flat annular form, which may in particular be provided with a hole in the centre thereof so that it can be passed through by the motor output shaft;
the closing means comprise legs extending substantially perpendicularly from the edge defining the periphery of the said screen;
the legs extend over a height substantially equal to the height of the interspaces of the stator;
the legs are uniformly arranged over the entire circumference of the screen;
the number of legs on the screen is equal to the number of interspaces on the stator;
the screen is fixed on the stator.

Advantageously, the screen as described above is a first screen forming part of a cover of the stator further comprising a second screen arranged to cover the stator on the axial side of the stator opposite to the side covered by the said first screen, between the said stator and the support means, the said second screen being also electrically connected to the support means and to the electrical earth.

In this context, the following may be envisaged:
the second screen extends transversely relative to the motor output shaft;
the second screen extends over the whole surface of the stator;
   the second screen has a substantially flat annular form, which may in particular be provided with a hole in the centre thereof so that it can be passed through by the motor output shaft;
   the closing means extend substantially perpendicularly from the edge defining the periphery of the second screen;
the second screen is fixed on the stator;
   the second screen extends axially, between the stator and the said support means;
   the second screen extends substantially as a continuation of the plates mounted on the periphery of the said stator;
the second screen has the form of an annular rim;
the closing means extend substantially axially as a continuation of the wall forming the said annular rim;
the second screen is fixed on the support means;
   the closing means are mounted on the first screen and on the second screen; on the one hand the closing means mounted on the first screen extend opposite the closing means mounted on the second screen, the said closing means extending over an axial dimension slightly smaller than half the axial dimension of the stator; on the other hand the two screens are arranged in relation to the stator so that the interspaces between the teeth of the stator are filled alternately by a closing means mounted on the first screen and by a closing means mounted on the second screen, the said closing means extending over an axial dimension substantially equal to the axial dimension of the stator;
the two screens have common earthing means;
   the common earthing means are formed by at least one fixing screw passing through the stator, in contact with at least the second screen and the first screen, so as to engage in the support means;
   the first screen and/or the second screen are made of an electrically conductive material, which may be for example aluminium;
   the output shaft of the motor is rotationally mounted inside the support means by means of rolling bearings;
in the case where the said support means have the form of a plate and in particular of a shank which is arranged projecting from the plate and around which the stator may be mounted, the plate of the support means forms a heat dissipator provided with an electronic control board, in particular for energizing the stator windings;

the rotor, which is arranged around the stator, has at least one permanent magnet, the interaction of which with the said coils supplied with current produces a rotational movement of the rotor around the stator.

The invention also relates to a system for heating, ventilating and/or air-conditioning a motor vehicle, comprising at least one air pulsation device in accordance with that described above.

Further characteristic features and advantages of the invention will become clear from reading of the detailed description of an embodiment which is provided below and which may be understood with reference to the attached figures in which:

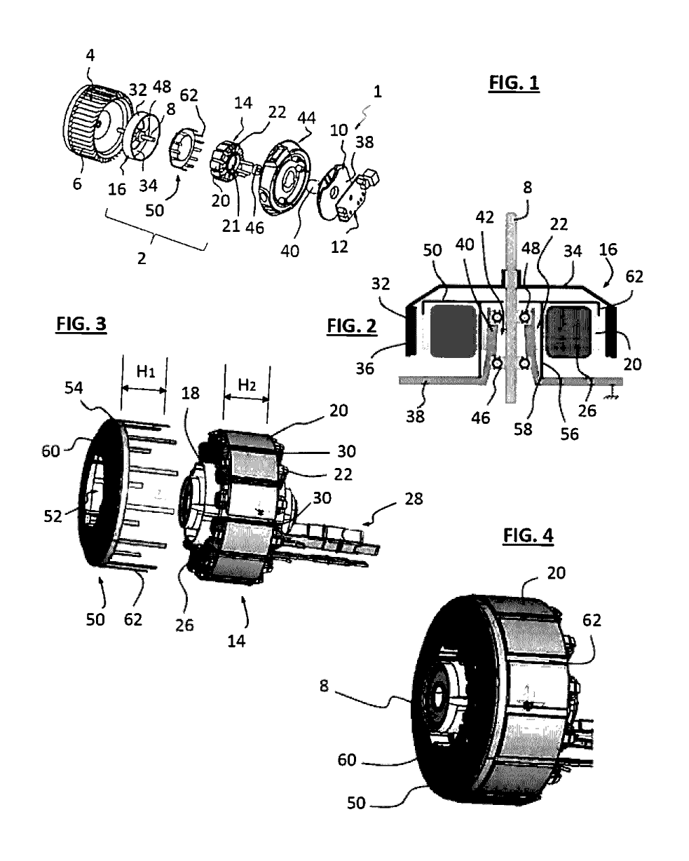

FIG. 1 is a perspective exploded view of an air pulsation device according to the invention;

FIG. 2 shows in schematic form an air pulsation device comprising according to the invention axial means for confining the electromagnetic radiation and means for closing the interspaces between the teeth of the stator visible in FIG. 1;

FIG. 3 is a perspective view of a stator equipping an electric motor in an air pulsation device according to the invention and a screen forming axial confinement means, the said screen having closing means according to the invention designed to be seated in the interspaces between the stator teeth;

FIG. 4 is a view similar to that shown in FIG. 3 where the screen has been assembled on the stator, the closing means being seated inside the interspaces between the stator teeth;

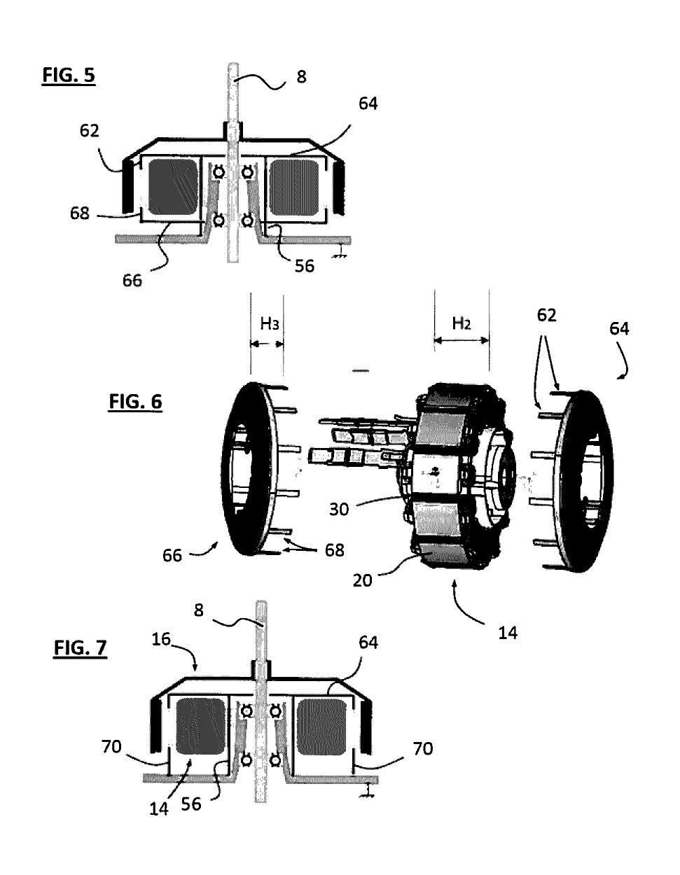

FIG. 5 shows in schematic form an air pulsation device comprising according to a particular embodiment of the invention axial confinement means with two screens arranged on either side of the stator;

FIG. 6 is a perspective view of a stator and axial confinement means with two screens, according to FIG. 5;

FIG. 7 shows in schematic form an air pulsation device comprising axial confinement means with two screens for this same radiation, according to a variation of embodiment; and

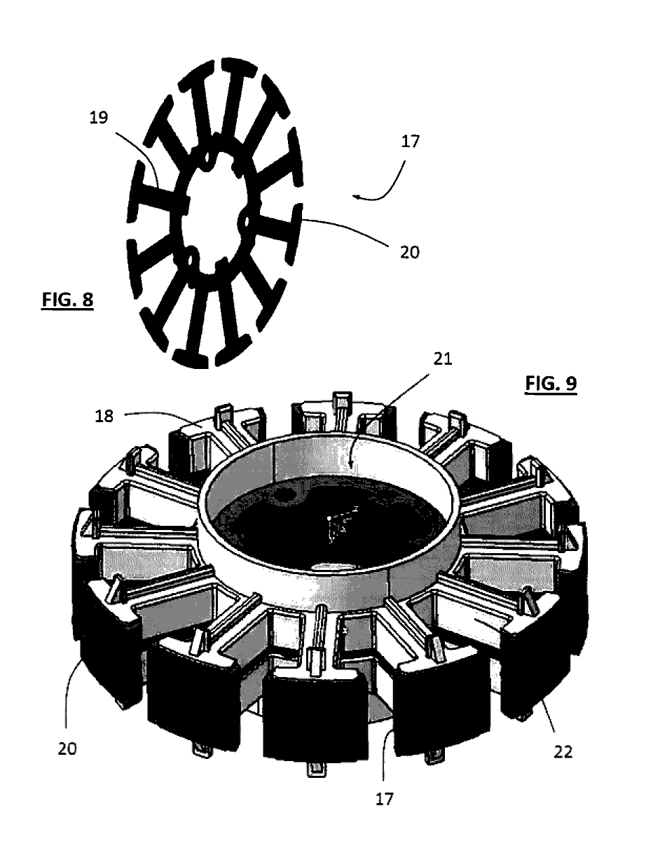

FIGS. 8 and 9 are views of elements forming the stator of an air expulsion device, i.e. a lamination (FIG. 8) and a housing moulded on a stack of these laminations (FIG. 9).

An air pulsation device 1, which is able to draw in and blow out air, comprises at least one electronic-switching electric motor 2 which may in particular be designed to rotationally drive a ventilation wheel 4, of the type here having fins 6, by means of an output shaft 8 of the electric motor. The device may further comprise at least one support means 10 incorporating several functions including supporting the electric motor 2, cooling the components of the said device and supporting an electronic control board 12 for controlling the said electric motor.

The electric motor comprises mainly an inducing stator 14 and an induced rotor 16 supporting the output shaft 8 designed to drive the ventilation wheel 4. The stator 14 is rigidly connected to the support means 10 of the electric motor, and the rotor 16 is arranged around the stator 14 so as to be rotationally driven under the action of the magnetic fields generated by the windings and the magnets associated with the rotor and stator.

The stator 14 has a form generated by revolution about a main longitudinal axis, substantially parallel to the axis of rotation of the rotor. The stator comprises a stack of laminations 17 (one lamination being visible in FIG. 8) and a housing 18 covering said stack, the said housing being made of plastic. The laminations 17 of the stator are stacked along the main axis of revolution, each lamination designed to be stacked having the form of arms 19 arranged star-like around a central ring and being extended at their free end by a bar 20 perpendicular to the said arm.

The housing 18 of the stator, which is visible in detail in FIG. 9, is in the form of two shells mounted on either side of the stack of laminations and each has an annular central wall which defines the contour of an inner bore 21 and an inner face of which is extended by a plurality of teeth 22 arranged radially in star form. It can be understood that the housing is moulded onto the stack of laminations such that the teeth of the housing cover the arms of the laminations, the bars of the laminations extending beyond the free radial end of the teeth. The stator 14 comprises an excitation coil composed of several phases, each comprising at least one wire winding 26, the output ends of which are electrically connected to energization means not shown here (only the connection means 28 being visible in particular in FIG. 3).

In a particular embodiment, the stator comprises twelve teeth which are three-phase wound. Winding of the wire is performed around the teeth, each tooth having a winding element. And as shown, the stacks of laminations 17 emerging at the free radial end of the housing are designed to provide an interspace 30 between each of the teeth 22 so as to leave the space necessary for performing winding of the wire around the teeth.

The rotor 16 has a bell-like form, with an annular rim 32 and a closing wall 34 arranged at one end of the said rim. The closing wall may have a flat form substantially perpendicular to the axis of the rim or else an Inwardly curved form undercut in the rim and supports in its centre the motor output shaft 8.

The rim 32 has a diameter greater than the outer diameter of the stator so that the rotor may cover the stator. The rim has an inner face which is directed towards the stator in this covering position and at least one permanent magnet 36 is arranged on this inner face of the rotor rim.

When the motor is assembled, the stator 14 is arranged in the body of the rotor 16 bounded by the rim 32. The rotor and the stator are thus arranged so that the permanent magnet 36 mounted on the rotor 16 is constantly arranged in the magnetic field generated by the coils of the stator 14 when the latter are supplied with current, so as to generate a rotational movement of the rotor around the stator.

In the air pulsation device 1 comprising the electric motor 2 according to the invention, the stator 14 and the rotor 16 are arranged so that the closing wall 34 of the rotor is directed towards the ventilation wheel 4 and the stator 14 is arranged facing the support means 10. The latter has here the form of a plate 38 and a shank 40 arranged projecting from the plate and having an internal channel 42 emerging substantially in the centre of the plate, and this support means is fixed in relation to the structure of the vehicle, here by means of a frame 44 shown in FIG. 1.

The plate 38 extends in a plane substantially perpendicular to the axis of revolution of the internal channel of the shank 40. The shank, which is substantially cylindrical, is designed to be housed inside the inner bore 21 of the stator 14 and to receive the motor output shaft 8 rigidly connected to the rotor 16, so that it can be understood that this support means 10 ensures correct positioning of the rotor 16 in relation to the stator 14. It can be seen in FIGS. 1, 2, 5 and 7 that the shank 40 and the plate 38 form a single piece, it being understood that the support means is single-piece since the separation of the shank and the plate causes destruction of either one of these components. The plate 38 has in the figures a disc-like form, but it is understood that it may take other forms, for example a rectangular, square, elliptical, or other form.

The plate 38 of the support means forms a heat dissipator provided with an electronic control board 12, in particular for energizing the coils of the stator. The electronic control board is arranged on the side of the plate 38 opposite to that where the shank 40 is located.

Preferably the support means 10 is made of metal and may be thermally coupled to the device by means of a thermal paste. Thus, the plate 38 acting as a heat dissipator may effectively cool the electronic member by means of heat conduction. Moreover, the fact that the support means is made of metal and connected to the earth of the electronic member allows blocking of the electromagnetic radiation emitted by the electronic member, which radiation may disturb operation of the electric motor. Moreover the fact that the support means is made of metal means that the stator 14 may be connected to earth via the support means 10. In fact, the plate 38 of the support means 10 is fixed relative to the structure of the vehicle, via the frame 44 here, so that the support means is considered to be electrically connected to earth. Preferably, the support means is made of aluminium so that characteristics of lightness and good heat conduction are associated with this part.

All this can be seen in particular in FIGS. 2, 5 and 7: the stator 14 is fixed onto the support means 10 and the rotor 16 is arranged so as to rotate about the stator 14. In particular, the stator is arranged around the shank 40, being in contact with the outer side of the shank, while the rotor 16 is received, by means of the output shaft 8 to which it is rigidly connected, inside the inner channel 42 of the shank. The electrical energization of the coil wires creates magnetic fields which force the rotation of the rotor driven by the permanent magnet 36 which it carries. This results in driving of the output shaft 8 of the motor which as shown is supported by the rotor 16 and is rotationally mounted inside the shank 40 of the support means by means of bearings.

Two bearings 46, 48 are inserted inside the support means 10 so as to serve as a rotational guide for the output shaft 8 of the motor driven moreover rotationally by the rotor 16. These bearings may be ball bearings, as shown schematically, but it is understood that they could take the form of roller bearings, needle bearings or the like.

The ventilation wheel 4 of the air pulsation device 1 is rigidly connected to the free end of the output shaft 8 of the motor which extends on the opposite side to the stator 14 and the support means 10 and it comprises, arranged on its periphery, a plurality of fins 6. The rotation of the rotor rotationally drives the wheel which helps produce the pulsed air by means of the fins.

Particularly noteworthy according to the invention is the fact that the electric motor 2 formed by the rotor 16 and the stator 14 further comprises confinement means for preventing propagation of the electromagnetic radiation outside of the motor and the air pulsation device.

In particular the motor comprises radial confinement means, namely means which are able to limit propagation of this electromagnetic radiation substantially perpendicularly relative to the longitudinal axis of the output shaft of the motor.

The inner side of the central annular wall of the said stator is in contact with the shank 40 arranged projecting from the plate 38, it being understood that the single-piece part formed by the shank 40 and the plate 38 is made of metal and connected to an electrical earth. As a result the metal laminations 17 are connected to the electrical earth and the bars 20 arranged radially at the free end of the laminations form the means for limiting the electromagnetic radiation.

In order for these radial confinement means to be effective, it must be ensured that the laminations 17 are correctly connected to the electrical earth and that there is therefore a stable contact between the stator 14 and the support means 10. It may be possible, for example, to provide the inner bore 21 of the stator with a frustoconical form and the outer profile of the shank 40 of the support means onto which the stator 14 is fitted also with a corresponding frustoconical form. In this way it is ensured that there is contact along the whole periphery of the shank when the stator is fitted onto the support means.

Moreover, the electromagnetic radiation confinement means according to the invention may be axial confinement means and comprise at least one additional screen made of a conducting material, in particular aluminium, and electrically connected to earth. It is possible in particular to envisage arranging such a screen on one side or the other of the stator 14, or on both sides.

In FIGS. 2 and 3, a first screen 50 is arranged transversely relative to the output shaft 8, between the stator 14 and the rotor 16. In order to form an effective confinement means, the first screen 50 extends transversely over the whole diameter of the stator.

As shown in FIG. 3, the first screen 50 may have a substantially flat annular form provided in the centre with a bore-hole 52 so that it can be passed through by the output shaft of the motor which extends between the rotor and the stator and so as to allow an air flow necessary for cooling the coils of the motor. The first screen 50 may have, as a continuation of its peripheral edge 54, a uniform flanged edge along the whole circumference of the first screen.

The first screen 50 is fixed onto the stator 14. The fixing means provided, by means of screwing, allow also the earthing of this first screen 50 on the plate 38. It is thus possible to use the fixing screws 50 for earthing the first screen 50, this earthing being necessary so that the first screen is able to limit propagation of the electromagnetic radiation. All of this is visible in FIG. 2: at least one of the fixing screws 56 passes for this purpose through the stator 14 so as to engage, on the other side of the stator, with the plate 38 inside a tapped hole 58. The electrical connection of the screen and earthing thereof is performed by means of the metal plate 38, the at least one metal fixing screw 56 engaged in the plate, and the contact between the screen and the screw head.

In FIGS. 3 and 4 it can be seen that the first screen 50 may be provided axially with ventilation orifices 60 which are distributed in a circular arrangement and spaced uniformly from each other. In particular, in the configuration shown where the stator 14 and the first screen 50 are arranged so that these ventilation orifices extend aligned with the interspaces 30 and the spaces left between the wound teeth of the stator, this allows efficient cooling of the electromagnetic means mounted on the rotor 16 and the stator 14.

The first screen 50 comprises advantageously legs 62 extending substantially perpendicularly from the peripheral edge of the screen. These legs extend over a height H1, as indicated in FIG. 3, and are uniformly arranged along the whole circumference of the screen. These legs 62 form means for closing the interspaces 30 formed in the stator between two adjacent teeth 22. When the first screen is assembled on the stator, the legs are seated inside these interspaces and they lie flush with the metal bars 20 which project from the adjacent teeth 22 so as to form a peripheral surface of the stator which is substantially continuous. The height H1 of the legs corresponds substantially to the height H2 of the stack of laminations, as indicated in FIG. 3, and the width of the legs is slightly smaller than the width of the interspaces so that each of the legs may be inserted inside a respective interspace. The screen is provided with a number of legs 62 corresponding to the number of interspaces 30 on the stator. The closing legs 62 are advantageously guided and kept in place by the shells forming the housing 18 and moulded onto the stack of laminations, so as to be correctly inserted and fully fill the corresponding interspaces.

It can be understood that these closing means formed by the legs improve the radial confinement of the electromagnetic radiation, forming a substantially continuous partition over the entire circumference of the stator, each element of this partition, whether it be the bars 20 of the lamination stack or the legs 62, being connected to the electrical earth as explained above. It is of particular interest according to the invention that these means for complementing radial confinement of electromagnetic radiation are mounted on means for performing axial confinement of this same radiation.

A description will now be provided, in particular with reference to FIGS. 5 to 7, of particular embodiments where two screens are provided so as to form a more effective cover of the stator. A first screen 64 is arranged so as to cover the stator 14, as described above, between the rotor 16 and the stator 14, and a second screen is arranged on the axial side of the stator 14 opposite to the side covered by the said first screen 64, namely between the said stator 14 and the plate 38. This second screen is also made of aluminium like the first screen.

Owing to the presence of the plate, this second screen may have several variants. In a first variant, shown in FIGS. 5 and 6, the second screen 66 extends transversely relative to the axis of the motor output shaft and has a form similar to that of the first screen described above, being symmetrical in relation to the stator. In this way, the second screen 66 extends radially over the entire diameter of the stator and it comprises a second series of legs 68 which extend perpendicularly from the peripheral edge of the screen. As shown in FIG. 5 a second series of legs 68 corresponding to the number of interspaces 30 in the stator is also provided on the second screen. And each of these legs extends over a height H3, as indicated in FIG. 6, substantially equal to half the height H2, and the legs 62 of the first screen 50 extend over the same height H3 as that of the second legs 68 of the second screen. Thus, it can be understood that, during assembly of the screens around the stator, a leg 62 of the first screen and a second leg 68 of the second screen are positioned in an interspace 30, each closing half of the said zone.

By way of a variant not shown, the legs 62 of the first screen 50 and the second legs 68 of the second screen could each extend over a height H1 equivalent to the height of the interspaces and the number of legs of the first screen, as well as the number of legs of the second screen, could be equal to half the number of the stator interspaces, the legs of the first and second screens filling alternately the interspaces 30.

At least one of the fixing screws 56 allows earthing of the first screen 50 and the second screen 68, for example at a same substantially zero electrical potential of the plate 38. The presence of two screens is able to ensure optimum axial confinement of the electromagnetic radiation and this may allow radial closing legs to be provided for the stator which are stronger, since they are shorter.

According to a second variant, shown in FIG. 7, the second screen 70 may extend axially, substantially as a continuation of the plates 24 mounted on the periphery of the said stator 14, the second screen 70 thus having the form of an annular rim. In this case, it is possible to fix the second screen both on the stator 14 and on the plate 38. Fixing of the second screen 70 on the plate 38 may in particular thus be performed by second fixing screws which cooperate with corresponding tapped bore-holes formed in the secondary shanks projecting from the plate around the shank. Fixing legs, extending perpendicularly from the rim, ensure fixing of the second screen and earthing.

The description above aims to explain how the invention is able to achieve the predefined aims and in particular provide an air pulsation device which limits the propagation of electromagnetic radiation, by devising confinement means which are simple to manufacture, simple to mount and particularly effective. In particular, confinement is made possible in all directions, with both radial confinement and axial confinement, the axial confinement means being provided with radial confinement means which complement those provided elsewhere. It should be noted that the invention is not limited to only the air pulsation devices according to the embodiments explicitly described with regard to FIGS. 1 to 7. By way of example, it is possible, without departing from the scope of the invention, to modify the form of the screen since it forms part of a casing enclosing in a sealed manner at least one side of the stator.

1. An air pulsation device comprising:
an electronic-switching electric motor comprising a rotor and a stator,
wherein the stator has a plurality of teeth arranged radially in star-like manner around a longitudinal axis so that an interspace for winding a magnetic coil around each of the teeth is formed between two adjacent teeth;
a means for supporting the electric motor that is in contact with the stator, the support means being metallic and electrically connected to an electrical earth; and
at least one screen electrically connected to the support means, the at least one screen comprising closing means which extend along the longitudinal axis so as to fill at least one of the interspaces between two teeth of the stator.

2. The air pulsation device according to claim 1, wherein the screen extends transversely between the rotor and the stator.

3. The air pulsation device according to claim 2, wherein the screen extends over the entire surface of the stator.

4. The air pulsation device according to claim 1, wherein the screen has a substantially flat annular form.

5. The air pulsation device according to claim 1, wherein the screen is provided in the centre with a bore-hole for passing through by an output shaft of the motor.

6. The air pulsation device according to claim 5, wherein the output shaft is rotationally locked with the rotor and comprises a ventilation wheel mounted on an opposite end.

7. The air pulsation device according to claim 1, wherein the closing means comprise legs extending substantially perpendicularly from the edge defining the periphery of the screen.

8. The air pulsation device according to claim 7, wherein the legs extend over a height substantially equal to the height of the interspaces of the stator.

9. The air pulsation device according to claim 8, wherein the legs are uniformly arranged along the entire circumference of the screen.

10. The air pulsation device according to claim 9, wherein the number of legs on the screen is equal to the number of interspaces on the stator.

11. The air pulsation device according to claim 2, wherein the screen is fixed on the stator.

12. The air pulsation device according to claim 1, wherein the screen is a first screen forming part of a cover of the stator and further comprising a second screen arranged to cover the stator on the axial side of the stator opposite to the side covered by the first screen, between the stator and the support means, the second screen being also electrically connected to the support means and to the electrical earth.

13. The air pulsation device according to claim 12, wherein the second screen extends transversely relative to a motor output shaft.

14. The air pulsation device according to claim 13, wherein the second screen extends over the entire surface of the stator.

15. The air pulsation device according to claim 13, wherein the second screen has a substantially flat annular form provided with a hole in the centre thereof so that it can be passed through by the motor output shaft and curved peripherally so as to come into contact with the radial end of the stator.

16. The air pulsation device according to claim 12, wherein the closing means consist of second legs extending substantially perpendicularly from the edge defining the periphery of the second screen.

17. The air pulsation device according to claim 11, wherein the second screen is fixed on the stator.

18. The air pulsation device according to claim 10, wherein the second screen extends axially, between the stator and the support means.

19. The air pulsation device according to claim 18, wherein the second screen extends substantially as a continuation of the periphery of the stator.

20. The air pulsation device according to claim 19, wherein the second screen has the form of an annular rim.

21. The air pulsation device according to claim 20, wherein the closing means extend substantially axially as a continuation of the wall forming the annular rim.

22. The air pulsation device according to claim 16, wherein the second screen is fixed on the support means.

23. The air pulsation device according to claim 10, wherein the closing means are mounted on the first screen and on the second screen.

24. The air pulsation device according to claim 23, wherein the closing means mounted on the first screen extend facing closing means mounted on the second screen, the closing means extending over an axial dimension slightly smaller than half the axial dimension of the stator.

25. The air pulsation device according to claim 21, wherein the two screens are arranged in relation to the stator in such a way that the interspaces between the teeth of the stator are filled alternately by a closing means mounted on the first screen and by a closing means mounted on the second screen, the closing means extending over an axial extension substantially equal to the axial dimension of the stator.

26. The air pulsation device according to claim 10, wherein the two screens have common earthing means.

27. The air pulsation device according to claim 26, wherein the common earthing means are formed by at least one fixing screw passing through the stator, in contact with at least the second screen and the first screen, so as to engage in the support means.

28. The air pulsation device according to claim 1, wherein the first screen and/or the second screen are made of a material with a high electrical conductivity.

29. The air pulsation device according to claim 1, wherein an output shaft of the motor is rotationally mounted inside the support means using bearings.

30. The air pulsation device according to claim 1, wherein the support means comprises at least one plate which forms a heat dissipator provided with an electronic control board for controlling energization of the stator coils.

31. The air pulsation device according to claim 1, wherein the rotor, which is arranged around the stator, has at least one permanent magnet, the interaction of which with the coils supplied with current produces a rotational movement of the rotor around the stator.

32. A heating, ventilation and/or air-conditioning system for a motor vehicle, comprising at least one air pulsation device in accordance with claim 1.
